(19) United States
(12) Patent Application Publication
(10) Pub. No.: US 2021/0391825 A1
(43) Pub. Date: Dec. 16, 2021

(54) SOLAR RADIATION ABSORBING PANEL

(71) Applicant: Alexander Levin, Binyamina (IL)

(72) Inventor: Alexander Levin, Binyamina (IL)

(21) Appl. No.: 16/900,925

(22) Filed: Jun. 14, 2020

(51) Int. Cl. H02S 40/42; H02S 30/10

(52) U.S. Cl. CPC H02S 40/425; H02S 30/10

(57) ABSTRACT

This invention relates to flat plate solar collectors and, particularly, to solar panels applied in these flat plate solar collectors.

The proposed solar panel is designed as a shallow box, with rear and front walls, which are conditionally vertically positioned a most part of the external surface of the front wall is provided with a coating absorbing solar radiation.

In addition, the internal side of the rear wall is joined with an auxiliary perforated sheet.

There is a rectangular pipe, which is installed vertically or horizontally on the exterior side of the front wall and serves for passage of a liquid to be heated.

The solar panel is functioning as a flat heat pipe with zones of evaporation and condensation on the front wall.

Elastic deformations of the front and rear walls under difference between atmospheric and internal pressure allows to prevent overheating of liquid in the vertical rectangular pipe.

### BACKGROUND OF THE INVENTION

This invention relates to flat plate solar collectors and, in particular, to solar radiation absorbing panels applied in these flat plate solar collectors.

In more particular, the invention relates to the flat plate solar collectors, which apply a principle of a heat pipe for their functioning.

There is U.S. Pat. No. 4,437,456, which discloses such flat plate solar collector.

U.S. Pat. No. 4,437,456 describes a heat pipe heat collector to be used in a gravity-assist mode; this solar collector comprises:

(a) an un-evacuated sealable housing means containing non-condensable gas, said housing means having a first end and a second end and having a wall extending substantially between said first end and said second end through which wall heat energy can enter said housing means when said housing means is sealed;

(b) a nonporous divider means extending substantially between said first end and said second end which divides said housing into a first portion and a second portion wherein said first portion and said second portion have connecting spaces therebetween located near said first end and near said second end;

(c) wick means located within said first portion so that heat energy entering said heat collector will heat said wick means so as to cause a first liquid located on said wick means to evaporate in the presence of said non-condensable gas; and

(d) a condenser means located near said first end and near said divider means and having an inlet and an outlet means for passing a second liquid into and out of said condenser means, said condenser means condensing vapor of said first liquid, which condensed vapor is then conducted onto said wick means so that substantially only said non-condensable gas will circulate from said first end to said second end through said second portion while most of said first liquid remains in said first portion.

However, this patent has some drawbacks:

1. Presence of significant amount of non-condensable gases causes sharp decrease of heat transfer coefficient for condensation of vapour of the working fluid on the condensation zone.

2. Circulation of gaseous medium in the internal space of the housing is very weak.

3. The patent does not describe technical means providing tight contact of the wick with the wall heated by solar radiation.

“A screen wick is also believed to be suitable, provided that the backing is uniformly attached to the screen wick” (Col. 6. ln. 66-68).

We see that it is only desire to apply some means for tight contact between the screen wick with the back side of the solar radiation absorbing sheet without a technical solution, which implements this desire.

US Patent Application No. 20120291770 describes a solar thermal collector with means for limiting stagnation temperatures and preventing damage, which includes: temperature limiting is provided by the insulated solar panel, isolating internal components from the environment, using passive closed systems within the sealed solar thermal collector, while also allowing alternative implementations as active systems and/or portions of the temperature limiting system outside the sealed solar thermal collector. A heat pipe can be used as a passive thermal switch, where the temperature induced action at a predetermined temperature causes an abrupt transition from a state of thermal isolation to a state of strong thermal coupling. Additionally, a set of siphon circulation pipes provides a passive closed system for temperature limiting.

In addition, there are some US patents, which disclose flat heat pipes used for heat dissipation from small electronic components. U.S. Pat. Nos. 5,560,423, 73,920,369, 9,995,537, 9,551,538, 9,565,786, 8,305,762, 7,392,836, 7,392,836, 6,167,948 are related to these patents.

However, these technical solutions are not suitable for construction of a solar radiation absorbing panel functioning in a contrary manner: collection of heat energy from large area with transferring this collected heat energy to relatively small area, which is in tight thermal contact with a pipe applied for circulation of water or another liquid medium to be heated.

### BRIEF SUMMARY OF THE INVENTION

This invention relates to flat plate solar collectors and, particularly, to solar radiation absorbing panels applied in these flat plate solar collectors.

The proposed solar radiation absorbing panel is designed as a shallow metal box with a rear wall, a frame and a front wall; a most part of the external surface of the front wall is provided with a coating absorbing solar radiation. The front wall and the rear wall are conditionally positioned vertically (in an operation mode the solar radiation absorbing panel can be in tilted position).

The frame is sealingly joined with the front and rear walls. In such a way, the obtained shallow box can be evacuated via a special outlet/inlet connection from air and other non-condensable gases and filled with a working fluid and its vapour.

The front wall, the rear walls and the frame are assumed in the text of this invention to be in vertical position; however, in the operation mode the metal shallow box itself, the front and rear walls and the frame can be in vertical or tilted positions.

It should be noted that the lower section of the exterior side of the front wall, when the height of this lower section somewhat below the level of working fluid in the shallow box with its front wall positioned vertically, may be un-covered with a coating absorbing the visible spectrum of solar radiation.

Moreover, this lower section can be covered with a coating with low value of its absorption coefficient of visible spectrum radiation (less than 0.5) and significantly high value (more than 0.9) of its emissivity in the infrared range of electromagnetic spectrum. In such a way, this lower section of the front wall plays a role of a heat sink for the proposed solar radiation absorbing panel.

In addition, the internal side of the rear wall is joined with an auxiliary sheet provided with perforations.

This joint includes following components: two opposite edges of the auxiliary sheet are joined with the rear wall and/or interlocking means are applied for this joint; these interlocking means are distributed on the internal surface of the rear wall and the auxiliary sheet.

This invention proposes two versions of the interlocking means.

According to a first version there is several parallel helixes preferably from spring steel, these helixes are situated between the rear wall and the auxiliary sheet. The helixes are preferably have ellipsoidal contour in their axial directions, and the apexes of these ellipses are preferably straightened. The opposite apexes of each helix are fastened on the rear wall and the auxiliary sheet by strips, which, in turn, fixed at their terminal sections on the rear wall and the auxiliary sheet by holding clamps. In such a way, these helixes serve as spacers between the rear wall and the auxiliary sheet.

Another interlocking means comprise a set of cylindrical dimples in the rear wall, wherein these dimples are directed outwards. The rear wall and the auxiliary sheet are fabricated from ferromagnetic steel.

The cylindrical dimples serve for installation of permanent cylindrical magnets wherein their height somewhat larger than the depth of the cylindrical dimples. In such a way, these permanent magnets serve at the same time as spacers between the rear wall and the auxiliary sheet.

There is a rectangular perforated wick joined with the auxiliary sheet and situated on the side of this auxiliary sheet, which is faced to the front wall. The rectangular wick is provided with the perforations in its vertical zone, which is intended to be in contact with the internal side of the vertical zone of the front wall, wherein the outer side of this vertical zone serves for installation of a vertical rectangular pipe; this vertical rectangular pipe (or a vertical circular pipe) should be described later.

The perforations of the rectangular wick are overlapped with perforations of the auxiliary sheet.

The rectangular wick with the set of the perforations covers a significate area of the internal surface of the front wall.

It should be noted that a most number of the auxiliary sheet's perforations are overlapped with non-perforated places of the wick.

In such a way these sort of the auxiliary sheet's perforations serves for passage of vapors generated by contact of the wick with the back side of the front wall at the spots of these auxiliary sheet's perforations.

The wicks can be manufactured from textile, glass wool or steel wool.

The inner space of the shallow box is evacuated at least partially from non-condensable gases and filled by a working fluid and its vapour.

Tight contact of this rectangular wick with the internal surface of the front wall is ensured by elastic deformation of the auxiliary sheet caused, in turn, by elastic deformation of the rear wall and pressure on this auxiliary sheet via the interlocking means and elastic deformation of the front wall in the opposite direction; these pressures and elastic deformations are caused by difference between subatmospheric pressure in the internal space of the box and atmospheric pressure in the surroundings.

A vertical rectangular pipe is installed on the external surface of the front wall with tight thermal contact with this front wall.

The perforations of the auxiliary sheet serve for penetration of the vapour, which are obtained by evaporation of the working fluid in the places of contact between the rectangular wick and the front wall, into the space between the auxiliary sheet and the rear wall with following ingress of the vapour via the perforations of the auxiliary sheet and the perforations of the rectangular wick onto the internal surface of the front wall in the zone of its contact with the vertical rectangular pipe and following condensation of these vapour.

Obtained condensate is soaked by connection straps between the perforations of the rectangular wick and redistributed by capillary force along the entire rectangular wick.

The vertical rectangular pipe may be provided with an insert, which is reversable deformed with water freezing; it prevents destruction of the rectangular pipe in the freezing conditions. For example, this insert can be manufactured as a U-shaped profile from resilient foamed rubber with closed porosity.

The wall of the vertical rectangular pipe, which is in contact with the front wall of the shallow box, can be provided at its internal side with longitudinal fins; it allows intensification of heat transfer from the condensation zone of the front wall to the fluid medium flowing in the vertical rectangular pipe. The extreme sections of the vertical rectangular pipe are protruded from the contour of the front wall and are provided with fittings allowing their connection with common polymer or metal pipes.

The exterior side of the rectangular pipe may be covered with a coating with low value of absorption coefficient of visible spectrum of solar radiation and relatively high value of emissivity in infrared spectrum of electromagnetic radiation.

It allows preventing overheating of a liquid medium in the rectangular pipe in stagnation conditions.

Changes of elastic deformations (their magnitudes and directions) of the front and rear walls and, therefore, the auxiliary sheet's displacement under change of subatmospheric pressure in the internal space of the shallow box to the atmospheric and supatmospheric pressure (this change is caused by elevation of temperature of the working fluid in the shallow box) discontinues the tight contact between the rectangular wick and the front wall; it limits stagnation temperature of the liquid medium (in the most cases—water) in the vertical rectangular pipe installed on the external side of the front wall and prevents overheating of the liquid medium.

In another version of the proposed design of the solar radiation absorbing panel, a horizontal rectangular pipe is applied instead of the vertical rectangular pipe (the front and rear walls are remained in their vertical positions); this horizontal rectangular pipe is preferably installed on the upper horizontal zone of the exterior side of the front wall. The wick in this case isn't provided with perforations in its upper horizontal zone and does not cover at all this horizontal zone.

The proposed design of the solar radiation absorbing panel ensures minimal heat losses by reverse thermosiphon phenomena at night time in a solar boiler operating according to the thermosiphon principle and applying the proposed solar radiation absorbing panel in its solar collector.

In another version, there is a vertical metal saddle, which is installed on the external side of the front wall by gluing, welding, soldering or brazing. This vertical saddle is provided with a longitudinal rectangular recess serving for fastening the vertical rectangular pipe with application of thermo-conducting grease, soldering or gluing.

In an addition version, the solar radiation absorbing panel in the form of the shallow box is provided with the vertical metal saddle, which is installed on the external side of the front wall by gluing, welding, soldering or brazing; this vertical metal saddle is provided with a vertical arc-wise recess serving for fastening the vertical circular pipe with application of thermo-conducting grease, soldering or gluing.

Application of the aforementioned vertical metal saddles with the rectangular or arc-wise recesses allows to apply immediate sealingly joining of the edges of the front and rear walls without usage of the aforementioned frame. The edges of the front wall and/or the rear wall are flanged in this case.

In the case of application of the vertical metal saddle with the arc-wise recess, the internal surface of the metal circular pipe may be protected by an anti-corrosion coating. It allows usage of the solar radiation absorbing panel for water heating in swimming pools.

An analogical horizontal saddle is used in the case of application of the horizontal rectangular pipe installed on the upper horizontal zone of the exterior side of the front wall.

### BRIEF DESCRIPTION OF THE SEVERAL VIEWS OF THE DRAWINGS

FIG. 1 demonstrates a transverse cross-section of a vertical rectangular pipe to be installed on the exterior side of a front wall.

FIG. 2a demonstrates the front view of the front wall with an installed vertical saddle provided with a vertical rectangular recess.

FIG. 2b demonstrates the front view of the front wall with the installed vertical saddle provided with the vertical rectangular recess and the rectangular pipe fastened in this rectangular recess.

FIG. 2c demonstrates the front view of the front wall with the installed horizontal saddle provided with the horizontal rectangular recess.

FIG. 2d demonstrates the front view of the front wall with the installed horizontal saddle provided with the horizontal rectangular recess and the rectangular pipe installed in this rectangular recess.

FIG. 3a demonstrates a front view of a wick with perforations.

FIG. 3b demonstrates the shorter version of the wick without perforations.

FIG. 4a and FIG. 4b demonstrate an axial contour and lateral view of a helix applied for interlocking of a rear wall and auxiliary sheet.

FIG. 5a demonstrates a horizontal transverse cross-section of a solar radiation absorbing panel and a rectangular pipe installed via a vertical saddle on a front wall of the solar radiation absorbing panel with a helix applied for interlocking between a rear wall and an auxiliary sheet.

FIG. 5b demonstrates a vertical transverse cross-section A-A of the solar radiation absorbing panel and the rectangular pipe installed via the vertical saddle on the front wall of the solar radiation absorbing panel with the helixes applied for interlocking between a rear wall and the auxiliary sheet.

FIG. 6a demonstrates a horizontal transverse cross-section of a solar radiation absorbing panel and a rectangular pipe installed via a horizontal saddle on a front wall of the solar radiation absorbing panel with a helix applied for interlocking between a rear wall and an auxiliary sheet.

FIG. 6b demonstrates a vertical transverse cross-section A-A of the solar radiation absorbing panel and the rectangular pipe installed via the auxiliary sheet horizontal saddle on the front wall of the solar radiation absorbing panel with the helixes applied for interlocking between a rear wall and an auxiliary sheet.

FIG. 7a demonstrates a horizontal transverse cross-section of a solar radiation absorbing panel and a rectangular pipe installed on the front wall of the solar radiation absorbing panel via a vertical saddle, and with a set of permanent magnets applied for interlocking between a rear wall and an auxiliary sheet.

FIG. 7b demonstrates a vertical transverse cross-section A-A of the solar radiation absorbing panel with the rectangular pipe installed via the vertical saddle on the front wall of the solar radiation absorbing panel with a set of permanent magnets applied for interlocking between the rear wall and the auxiliary sheet.

### DETAILED DESCRIPTION OF THE INVENTION

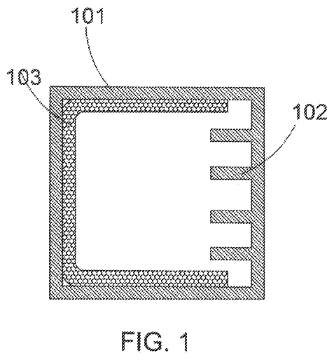

FIG. 1 demonstrates a transverse cross-section of a vertical rectangular pipe to be installed on the exterior side of a front wall.

It comprises: pipe 101; internal fins 102; an internal insert 103 from a porous rubber with closed porosity.

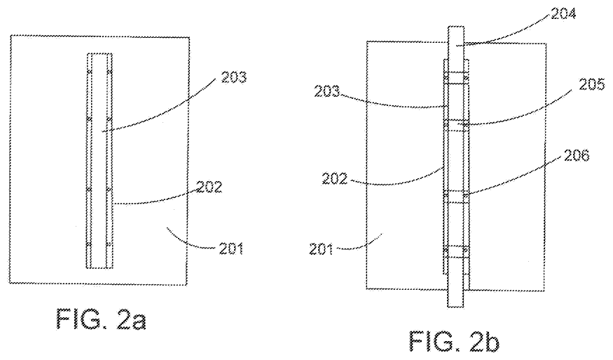

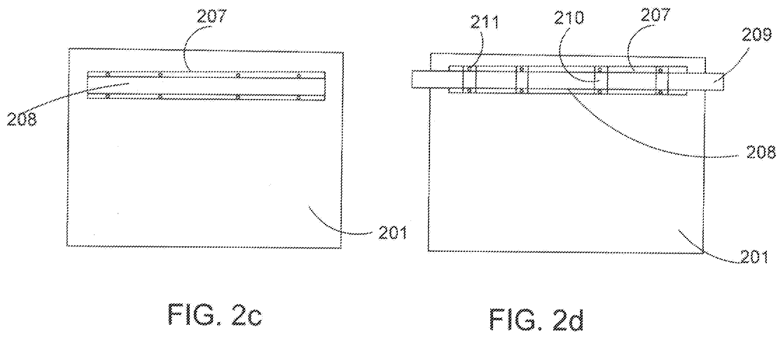

FIG. 2a demonstrates the front view of a front wall with an installed vertical saddle provided with a longitudinal rectangular recess.

It comprises the front wall 201; the vertical saddle 202 and its longitudinal rectangular recess 203.

FIG. 2b demonstrates the front view of the front wall with the installed vertical saddle provided with the vertical rectangular recess and a rectangular pipe installed in this rectangular recess.

It comprises the front wall 201; the vertical metal saddle 202 and its vertical rectangular recess 203; the rectangular pipe 204, which is installed in the vertical rectangular recess 203. The rectangular pipe 204 is fixed in the longitudinal recess 203 by pipe clips 205 and threaded studs 206.

FIG. 2c demonstrates the front view of the front wall with the installed horizontal saddle provided with the horizontal rectangular recess.

It comprises the front wall 201; a horizontal saddle 207 and its horizontal rectangular recess 208.

FIG. 2d demonstrates the front view of the front wall with the installed horizontal saddle provided with the horizontal rectangular recess and the rectangular pipe installed in this rectangular recess.

It comprises the front wall 201; a horizontal saddle 207; a rectangular pipe 209, which is installed in a horizontal rectangular recess 208. The rectangular pipe 209 is fixed in the horizontal recess 208 by pipe clips 210 and threaded studs 211.

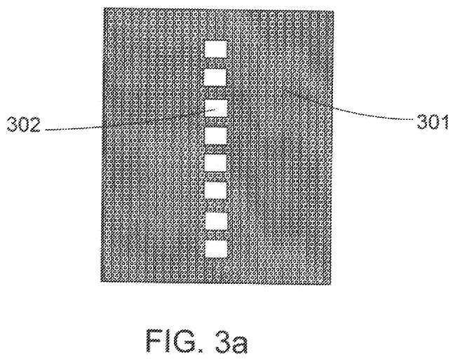

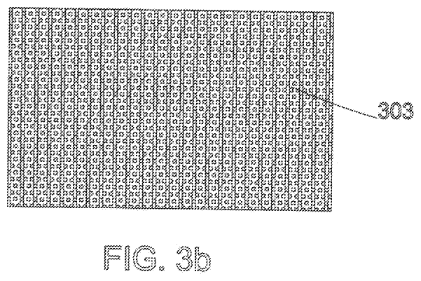

FIG. 3a demonstrates a front view of a wick with perforations. It comprises wick 301 itself and its perforations 302.

FIG. 3b demonstrates a front view of the shorter version of the wick without perforations.

It comprises wick 303 itself.

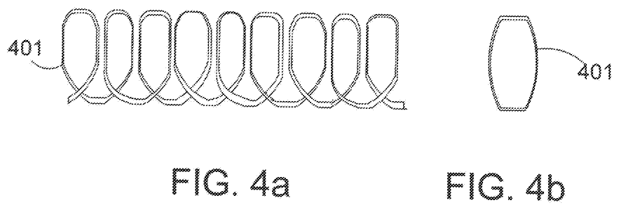

FIG. 4a and FIG. 4b demonstrate an axial contour and lateral view of a helix applied for mutual interlocking of a rear wall and an auxiliary sheet.

It comprises helix 401 itself.

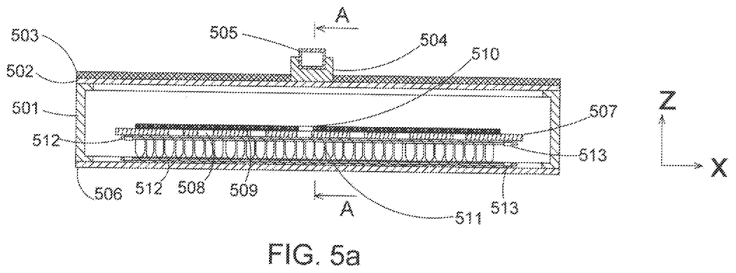

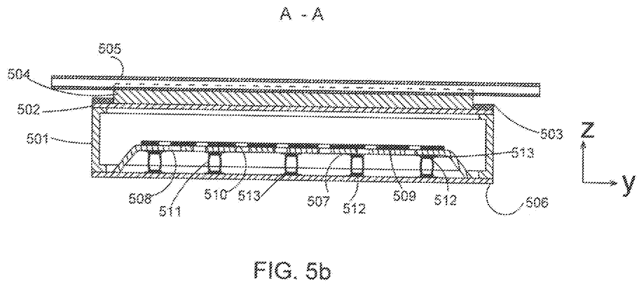

FIG. 5a demonstrates a horizontal transverse cross-section in co-ordinates XZ of a solar radiation absorbing panel and a rectangular pipe installed via a vertical saddle on a front wall of the solar radiation absorbing panel. The helixes are applied for interlocking a rear wall and an auxiliary sheet.

FIG. 5a comprises: a rectangular frame 501, a front wall 502 with a solar radiation absorbing coating 503, a vertical saddle 504 installed on the exterior side of the front wall 502 and a vertical rectangular pipe 505, which is joined with the vertical saddle 504 with tight thermo-conducting contact. This thermo-conducting contact can be ensured by welding, soldering or gluing.

A rear wall 506 and the front wall 502 are sealingly joined with frame 501.

There is an auxiliary sheet 507 with an array of perforations 508. The side of the auxiliary sheet 507 facing the front wall 502, is provided with a rectangular wick 509, which is joined with this auxiliary sheet 507.

The rectangular wick 509 is provided with an array of perforations 510 overlapped with perforations 508 of the auxiliary sheet 507.

The auxiliary sheet 507 and the rear wall 506 are mutually interlocked by helix 511, strips 512 and holding clamps 513.

It should be noted that the external side of the front wall 501, which is not occupied by the vertical saddle 502, is covered by coating 503, which absorbs solar radiation. This coating 503 can be a black paint or a selective coating with high coefficient of solar radiation absorption in the visible range of the solar spectrum (above 70%) and low emissivity in the infrared range of the electromagnetic spectrum (less than 20%).

The vertical saddle 502 and the outer walls of the vertical rectangular pipe 505 can be alternatively covered or not covered with a coating absorbing solar radiation.

This coating can be of different optical characteristics (absorption in the visible range of spectrum and emissivity in the infrared of spectrum) than the exterior coating of the front wall.

FIG. 5b demonstrates a vertical transverse cross-section A-A in co-ordinates Y Z (Y is the vertical co-ordinate) of the solar radiation absorbing panel and a rectangular pipe installed via a vertical saddle on a front wall of the solar radiation absorbing panel. The helixes are applied for interlocking the rear wall and the auxiliary sheet.

FIG. 5b comprises: the rectangular frame 501, the front wall 502 with the solar radiation absorbing coating 503, the vertical saddle 504 installed on the exterior side of the front wall 502 and a vertical rectangular pipe 505, which is joined with the vertical saddle 504 with tight thermo-conducting contact. This thermo-conducting contact can be ensured by welding, soldering or gluing.

A rear wall 506 is sealingly joined with frame 501.

There is the auxiliary sheet 507 with the array of perforations 508. The side of the auxiliary sheet 507 facing the front wall 502, is provided with the rectangular wick 509, which is joined with this auxiliary sheet 507.

The rectangular wick 509 is provided with the array of perforations 510 overlapped with perforations 508 of the auxiliary sheet 507.

The auxiliary sheet 507 and the rear wall 506 are mutually interlocked by helixes 511, strips 512 and holding clamps 513.

In addition, two opposite edges of the auxiliary sheet 507 are joined with the rear wall 506.

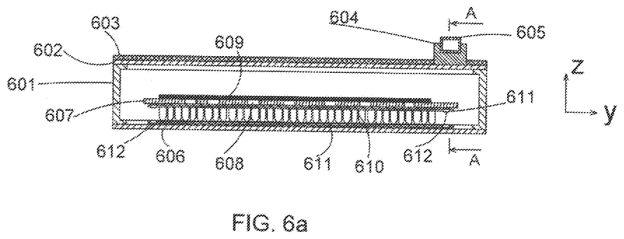

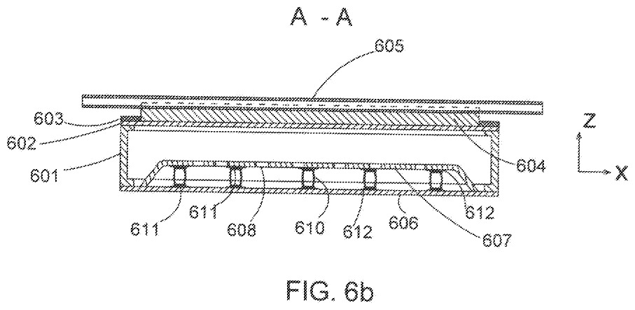

FIG. 6a demonstrates a transverse cross-section in co-ordinates Y Z (Y is the vertical co-ordinate) of a solar radiation absorbing panel, when a rectangular pipe is installed via a horizontal saddle on a front wall of the solar radiation absorbing panel.

Helixes are applied for interlocking a rear wall and an auxiliary sheet.

FIG. 6a comprises: a rectangular frame 601, a front wall 602 with a solar radiation absorbing coating 603, a horizontal saddle 604 installed on the exterior side of the front wall 602 and a horizontal rectangular pipe 605, which is joined with the horizontal saddle 604 with tight thermo-conducting contact. This thermo-conducting contact can be ensured by welding, soldering or gluing.

A rear wall 606 and the front wall 602 are sealingly joined with frame 601.

There is an auxiliary sheet 607 with an array of perforations 608. The side of the auxiliary sheet 607, which is facing the front wall 602, is provided with a rectangular wick 609 joined with this auxiliary sheet 607.

The auxiliary sheet 607 and the rear wall 606 are mutually interlocked by helix 610, strips 611 and holding clamps 612.

FIG. 6b demonstrates a horizontal transverse cross-section A-A in co-ordinates XZ of the solar radiation absorbing panel and the rectangular pipe installed via a horizontal saddle on a front wall of the solar radiation absorbing panel. The helixes are applied for mutual interlocking the rear wall and the auxiliary sheet.

FIG. 6b comprises: a rectangular frame 601, a front wall 602 with a solar radiation absorbing coating 603, a horizontal saddle 604 installed on the exterior side of the front wall 602 and a horizontal rectangular pipe 605, which is joined with the horizontal saddle 604 with tight thermo-conducting contact. This thermo-conducting contact can be ensured by welding, soldering or gluing.

A rear wall 606 and the front wall 602 are sealingly joined with frame 601.

There is an auxiliary sheet 607 with an array of perforations 608.

The auxiliary sheet 607 and the rear wall 606 are mutually interlocked by helixes 610, strips 611 and holding clamps 612.

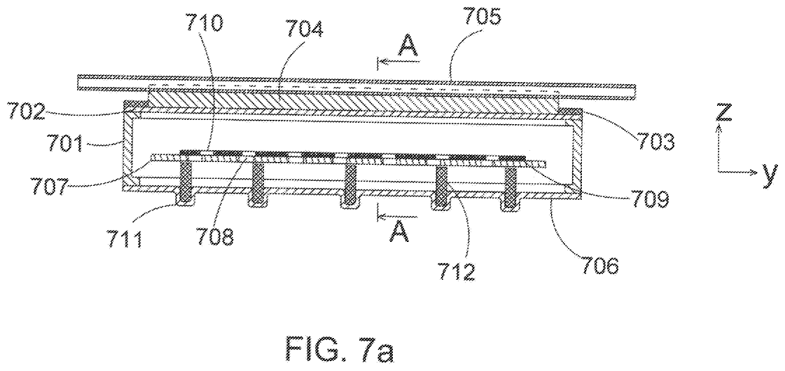

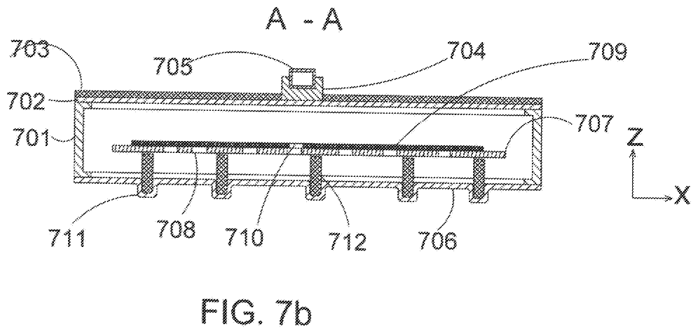

FIG. 7a demonstrates a horizontal transverse cross-section in co-ordinates XZ of a solar radiation absorbing panel and a vertical rectangular pipe installed via a vertical saddle on a front wall of the solar radiation absorbing panel. A set of permanent magnets is applied for mutual interlocking a rear wall and an auxiliary sheet of the solar radiation absorbing panel.

FIG. 7a comprises: a rectangular frame 701, a front wall 702 with a solar radiation absorbing coating 703, a vertical saddle 704 installed on the exterior side of the front wall 702 and a vertical rectangular pipe 705, which is joined with the vertical saddle 704 with tight thermo-conducting contact. This thermo-conducting contact can be ensured by welding, soldering or gluing.

A rear wall 706 and the front wall 702 are sealingly joined with frame 701.

There is an auxiliary sheet 707 with an array of perforations 708. The side of the auxiliary sheet 707 facing the front wall 702, is provided with a rectangular wick 709, which is joined with this auxiliary sheet 707.

The rectangular wick 709 is provided with an array of perforations 710 overlapped with perforations 708 of the auxiliary sheet 707.

The rear wall 706 and the auxiliary sheet 707 are preferably manufactured from ferromagnetic steel, and the rear wall is provided with an array of dimples 711 directed outwards.

The auxiliary sheet 707 and the rear wall 706 are mutually interlocked by permanent magnets 712, which are partially located in dimples 711.

FIG. 7b demonstrates a vertical transverse cross-section A-A in co-ordinates Y Z (Y is the vertical co-ordinate) of the solar radiation absorbing panel, when the permanent magnets are applied for interlocking between the rear wall and the auxiliary sheet.

FIG. 7b comprises: the rectangular frame 701, the front wall 702 with the solar radiation absorbing coating 703, the vertical saddle 704 installed on the exterior side of the front wall 702 and the vertical rectangular pipe 705, which is joined with the longitudinal saddle 704 with tight thermo-conducting contact. This thermo-conducting contact can be ensured by welding, soldering or gluing.

The rear wall 706 and the front wall 702 are sealingly joined with frame 701.

There is the auxiliary sheet 707 with an array of perforations 708. The side of the auxiliary sheet 707 facing the front wall 702, is provided with a rectangular wick 709, which is joined with this auxiliary sheet 707.

The rectangular wick 709 is provided with an array of perforations 710 overlapped with perforations 708 of the auxiliary sheet 707.

The rear wall 706 and the auxiliary sheet 707 are preferably manufactured from ferromagnetic steel, and the rear wall is provided with an array of dimples 711 directed outwards.

The auxiliary sheet 707 and the rear wall 706 are mutually interlocked by permanent magnets 712, which are partially located in dimples 711.

1. A solar radiation absorbing panel in the form of a shallow box; said shallow box comprises:
a rectangular frame;
a front wall, which is conditionally positioned vertically; said front wall is provided with a solar radiation absorbing coating on a most part of its exterior side; said front wall is joined sealingly with said rectangular frame;
a vertical rectangular pipe, which is joined with the exterior side of said front wall with tight thermo-conducting contact;
a rear wall, which is sealingly joined with said rectangular frame; the internal space of said shallow box is evacuated at least partially from non-condensable gases and filled with a working fluid and its vapour;
an auxiliary sheet with an array of perforations; the side of said auxiliary sheet, which is facing said front wall, is provided with a rectangular wick, which is joined with said auxiliary sheet; said rectangular wick is provided with an array of perforations overlapped with said perforations of said auxiliary sheet; positions of said wick's perforations conform location of the vertical zone of the front wall occupied by said vertical rectangular pipe;
said auxiliary sheet is joined with said rear wall at two opposite edges of said auxiliary sheet;
said rear wall and said auxiliary sheet are joined additionally at some points by interlocking means;
the internal space of said shallow box is filled with a working fluid and its vapour.

2. The solar radiation absorbing panel in the form of a shallow box as claimed in claim 1, wherein there is a vertical metal saddle, which is installed on the external side of the front wall by gluing, welding, soldering or brazing; said vertical metal saddle is provided with a vertical rectangular recess serving for fastening the vertical rectangular pipe with application of thermo-conducting grease.

3. The solar radiation absorbing panel in the form of a shallow box as claimed in claim 2, wherein the edges of the front and rear walls immediately sealingly joined without usage of a frame.

4. The solar radiation absorbing panel in the form of a shallow box as claimed in claim 1, wherein there is a horizontal metal saddle, which is installed on the external side of the front wall by gluing, welding, soldering or brazing; said horizontal metal saddle is provided with a horizontal rectangular recess serving for fastening a horizontal rectangular pipe with application of thermo-conducting grease.

5. The solar radiation absorbing panel in the form of a shallow box as claimed in claim 4, wherein the edges of the front and rear walls sealingly joined immediately without usage of a frame.

6. The solar radiation absorbing panel in the form of a shallow box as claimed in claim 2, wherein the vertical metal saddle is provided with a vertical arc-wise recess serving for fastening a vertical circular pipe with application of thermo-conducting grease, soldering or gluing.

7. The solar radiation absorbing panel in the form of a shallow box as claimed in claim 2, wherein the vertical metal saddle is provided with a vertical arc-wise recess serving for fastening a vertical circular pipe with application of thermo-conducting grease, soldering or gluing; the internal surface of the vertical circular pipe is covered with an anti-corrosion coating.

8. The solar radiation absorbing panel in the form of a shallow box as claimed in claim 1, wherein said vertical rectangular pipe is covered with a solar radiation absorbing coating.

9. The solar radiation absorbing panel in the form of a shallow box as claimed in claim 1, wherein said vertical rectangular pipe is covered with a coating, which possesses high value coefficient of emissivity in the infrared range of electromagnetic radiation.

10. The solar radiation absorbing panel in the form of a shallow box as claimed in claim 1, wherein said interlocking means are realized as a set of helixes, which are fixed on the rear wall and the auxiliary sheet by strips and clamps.

11. The solar radiation absorbing panel in the form of a shallow box as claimed in claim 1, wherein the rear wall is provided with an array of dimples directed outwards, said rear wall and auxiliary sheet are manufactured from ferromagnetic metals, and the interlocking means are realized as a set of permanent magnets; each said permanent magnet is partially positioned in one of said dimples.

12. The solar radiation absorbing panel in the form of a shallow box as claimed in claim 1, wherein the rectangular pipe is installed horizontally on the upper exterior section of the front wall and the rectangular wick is positioned and fixed on the lower section of the auxiliary sheet; said rectangular wick is not provided with perforations.

13. The solar radiation absorbing panel in the form of a shallow box as claimed in claim 1, wherein the internal side of the rectangular pipe, which is in contact with the front wall, is provided with longitudinal fins.

14. The solar radiation absorbing panel in the form of a shallow box as claimed in claim 1, wherein the vertical rectangular pipe is provided with an insert, which is reversable deformed with water freezing.

15. The solar radiation absorbing panel in the form of a shallow box as claimed in claim 1, wherein the lower section of the exterior side of the front wall, when the height of this lower section somewhat below the level of working fluid in said shallow box is un-covered with a coating absorbing the visible spectrum of solar radiation.

16. The solar radiation absorbing panel in the form of a shallow box as claimed in claim 1, wherein the lower section of the exterior side of the front wall, when the height of this lower section somewhat below the level of working fluid in said shallow box is covered with a coating with low value of its absorption coefficient of visible spectrum radiation (less than 0.5) and significantly high value (more than 0.9) of its emissivity in the infrared range of electromagnetic spectrum.
